(19) United States
(12) Patent Application Publication
(10) Pub. No.: US 2009/0317679 A1
(43) Pub. Date: Dec. 24, 2009

(54) Chromium Retention Layers for Components of Fuel Cell Systems

(76) Inventors: Michael Stanislowski, Wuppertal (DE); Klaus Hilpert, Juelich (DE); Ulrike Hilpert, Juelich (DE)

Correspondence Address: JORDAN AND HAMBURG LLP, 122 EAST 42ND STREET, SUITE 4000, NEW YORK, NY, 10168, US

(21) Appl. No.: 11/922,671

(22) PCT Filed: Jun. 23, 2006
(86) PCT No.: PCT/DE2006/001062

§ 371 Date: Mar. 18, 2009

(30) Foreign Application Priority Data
Jul. 2, 2005 (DE) 10 2005 030 925.9

(51) Int. Cl. H01M 2/02; H01M 8/04; H01M 8/00

(52) U.S. Cl. 429/26; 429/34; 427/115

(57) ABSTRACT

In accordance with a method for producing chromium retention layers for components of solid oxide fuel cells (SOFCs) made of chromium-containing alloys, the aluminum-containing component surface is subjected to elevated temperatures so that a gas-tight chromium retention layer forms. The layer produced in this manner effectively prevents vaporization of chromium from the basic material. Defects in the layer remedy themselves during operation of the fuel cell.

### BACKGROUND OF THE INVENTION

The invention relates to a method for producing chromium retention layers for components of solid oxide fuel cells (SOFCs).

A solid oxide fuel cell (SOFC) comprises a porous cathode, a gas-tight but oxygen ion-conducting electrolyte, and a porous anode. A fuel (e.g. CH₄ or hydrogen) is supplied at the anode and an oxidizing agent (e.g. air or oxygen) is supplied at the cathode. At temperatures between 600 and 1000° C., oxygen ions travel out of the oxidizing agent through the electrolyte into the anode space, where they react with the fuel. Electrons occur that deliver electrical energy for an external consumer and also deliver heat at the same time. In general a plurality of cells is combined to create a fuel cell stack since one individual cell produces only very little voltage.

As a rule components for solid oxide fuel cells are produced from heat-resistant steels containing chromium. The heat resistance of these steels is based on the embodiment of layers of Cr₂O₃ (chromium oxide formers) or Al₂O₃ (aluminum oxide formers) on the surface under operating conditions. Most aluminum oxide formers contain between 5 and 6% Aluminum and about 20% chromium. Aluminum oxide formers are generally pre-oxidized, typically for one hour at temperatures of about 1000° C., prior to use at temperatures below 950° C. in order to initially build up a stable α-Al₂O₃ layer. It is a disadvantage that at high temperatures, with air, steels containing chromium, in addition to the Cr₂O₃ cover layer, form volatile chromium compounds such as CrO₃ or CrO₂(OH)₂ that deactivate the cathode material and thus have a lasting negative effect on the performance of the fuel cell.

According to general requirements, this so-called degradation of the fuel cell during mobile applications can be no greater than 2% of the cell performance per 1000 h at 5000-10,000 h service life and during stationary applications can be no greater than 0.25% of cell performance per 1000 h at 40,000-100,000 h service life. At 800° C., approximately 6-7*10⁻¹⁰ kg chromium per second and square meter of surface area vaporizes from pure Cr₂O₃ layers. This quantity is enough to cause degradation of up to 50% cell performance per 1000 h when using for instance lanthanum strontium manganite (LSM) as cathode material. Some alloys form (Fe, Cr)₃O₄ or (Mn, Cr)₃O₄ spinel layers on the Cr₂O₃ layer, but these only weakly bind the chromium in the form of chromium oxide and still vaporize 1-4*10⁻¹⁰ kg m⁻² s⁻¹ of chromium. This is equal to 33-86% chromium retention relative to the pure Cr₂O₃ layers.

A chromium vaporization rate of less than 4.6*10⁻¹¹ kg m⁻² s⁻¹ is required in order to keep the degradation of the fuel cell below 2% per 1000 h for mobile long-term applications. This is equal to chromium retention of >93% with regard to vaporization of pure Cr₂O₃ layers. Experience has shown that a chromium vaporization rate of less than 6.5*10⁻¹² kg m⁻² s⁻¹ is required in order to keep the degradation of the fuel cell below 0.25% per 1000 h for stationary applications. This equals chromium retention of >99% relative to the vaporization of pure Cr₂O₃ layers.

It is known from DE 195 47 699 A1 that the vaporization rate of volatile chromium compounds from bipolar plates in fuel cell stacks can be reduced using an electrochemically applied protective layer made of e.g. iron, cobalt, or nickel. DE 44 10 711 C1 discloses a method for producing a corrosion-resistant layer made of Al₂O₃ in which an aluminizing process is first used to form intermetallic phases made of chromium and aluminum and these are converted to α-Al₂O₃ at temperatures of approximately 950° C. Layers produced in this manner have the disadvantage of a limited service life, since any defects that occur will not remedy themselves automatically. Defects occur inter alia when there is spalling in layer material due to frequent changes in temperature when the fuel cell is starting up or running down. In addition, in DE 44 10 711 C1 it is unresolved whether the corrosion-resistant layer is also advantageous with respect to chromium retention.

DE 103 06 647 A1 discloses a method for producing a protective layer on a chromium oxide-forming substrate, the layer forming at temperatures between 500 and 1000° C. and thus automatically regenerating at normal operating temperatures for solid oxide fuel cells. It is a disadvantage that according to the prior art the retentive effect is not adequate for satisfying the requirements in terms of long-term applications of the fuel cell. Moreover, the CoO, CuO, and MnO₂ starting materials are relatively expensive, and the production process does not permit components such as conduits and heat exchangers to be coated from the interior.

The object of the invention is therefore to provide a method for cost-effective production of effective chromium vaporization protective layers that can also completely coat components that have complex geometries. The object of the invention is also to provide chromium vaporization layers that have better chromium retention than protective layers according to the prior art. It is also the object of the invention to provide a component for a fuel cell that vaporizes less chromium during operation of the fuel cell than components according to the prior art.

### SUMMARY OF THE INVENTION

These objects are attained in accordance with the invention using a method, a protective layer, and a component.

In the framework of the invention it was found that a protective layer must not necessarily comprise α-Al2O₃ in order to effectively prevent the vaporization of chromium from a chromium-containing material. Metastable Al₂O₃ (e.g. γ- or θ-Al₂O₃) is also adequate for this. These metastable phases form on an aluminum-containing surface even at relatively low temperatures of 500 to 800° C. This is particularly advantageous for use in a solid oxide fuel cell because in general efforts are made to significantly reduce its operating temperature from the current 900 to 1000° C. The use of the metastable phases of Al₂O₃ is also not suggested by the prior art. Because the prevailing teaching is that a good cover layer that can be used like a corrosion-resistant layer must also comprise the most dense possible α-Al₂O₃. Such a layer is not normally formed at temperatures below 950° C.

For instance, an oxide layer made of α- and -Al₂O₃, which reduces chromium vaporization by more than 97% compared to pure Cr₂O₃ layers, forms on the aluminum-containing surface of a component for a fuel cell at temperatures of about 800° C., even after a short time. In fact, after 100 operating hours at this temperature, more than 99.7% of the chromium is retained without the component having been pre-oxidized prior to actual initial operation.

The temperature range in which metastable Al₂O₃ forms also includes the lower end of the working range in which solid oxide fuel cells are operated. Thus the layer regenerates itself if any damage occurs even if the fuel cell is operated in the lower load range or if the component is arranged outside of the actual fuel cell or outside of the actual fuel cell stack. Examples of this are heat exchangers, conduits, and housings. In order to increase the service life of the layer, even under cyclic thermal loads, there must be enough material available for the auto-repair. This material is always available if the surface of the component contains aluminum. However, if the surface first has to be enriched with aluminum prior to forming the chromium retention layer, the thickness of the zone enriched with aluminum is advantageously selected to be larger than is necessary for the first formation of the chromium retention layer.

A thick layer made of pure α-Al₂O₃ can form from the inventive layer when the fuel cell is employed at temperatures of 950° C. or more or at somewhat lower temperatures over extended periods, but this does not have a negative effect on chromium retention.

The components that are to be coated using the inventive method advantageously comprise a nickel-chromium alloy, an iron-nickel-chromium alloy, a cobalt-chromium alloy, or an iron-chromium alloy. Alloys of this type are very ductile. Aluminum oxide formers have the advantage that their surface already contains aluminum and does not have to be enriched with aluminum prior to formation of the chromium retention layer.

It was found in the framework of the invention that the chromium release of aluminum oxide formers (Fe20Cr5Al) at 800° C. without pre-oxidation is on the order of magnitude of 10⁻¹²-10⁻¹³ kg m⁻² s⁻¹, corresponding to chromium retention of 99.83 to 99.99%. This is completely consistent with the requirements cited in the foregoing for stationary use of fuel cells operated over extended periods.

Due to their high aluminum content, however, aluminum oxide formers are brittle and therefore are not suitable for all applications. Alloys with austenitic structure are better suited than alloys with ferritic structure due to the lower diffusion rate and the associated lower penetration depth of Al.

In order to enrich with aluminum the component surface made of a chromium oxide former in one embodiment of the invention a gas phase aluminizing process with low aluminum activity is advantageously used for components with fine structures such as heat exchangers. Instead of pure aluminum, the starting material used for this is generally an aluminum alloy. The aluminizing layers from this are better and contain fewer stresses. In one typical gas phase aluminizing process, the component is conditioned at 850 to 1080° C. for 2 to 24 hours in an inert atmosphere such as argon or in a reducing atmosphere such as hydrogen. It is disposed over a powder mixture that contains an aluminum alloy, an activator such as NH₄Cl or NH₄F, and a sinter inhibitor such as Al₂O₃.

The chromium released by aluminized NiCr and FeNiCr steels at 800° C. without pre-oxidation is for instance about 10⁻¹²-10⁻¹³ kg m⁻² s⁻¹, which corresponds to chromium retention of 99.83 to 99.99%. With respect to the aforesaid specifications, these materials are therefore suitable for use in fuel cells in long-term stationary operation.

The thinner the layer thickness, the more ductile the aluminizing layers at operating temperatures greater than 600° C., so that the occurrence of cracks in the layer can be avoided. In addition, by enriching with aluminum, aluminizing reduces the effective cross-section of the basic material located thereunder, and indeed the thicker the layer, the thicker the reduction is. This can become a problem in particular for thin-walled components. Preferably the build-up zone, which forms during aluminizing due to material deposition on the surface, and the diffusion zone, that is, the area that is enriched with aluminum through the diffusion of aluminum from the build-up zone, have thickness between 20 and 100 m, ideally between 20 and 50 m.

Components that are advantageously provided with the inventive chromium retention layers are in particular heat exchangers, conduits, pumps, and housings. The method is suitable for all components that do not have to be highly electrically conductive.

### DETAILED DESCRIPTION OF THE INVENTION

As regards the temporal progression of the chromium vaporization rates of an aluminum oxide former (Fe20Cr5Al) at 800, 900, and 1000° C., with no pre-oxidation, initially the chromium vaporization rate drops very rapidly while the Al₂O₃ layer forms. Even at 1000° C., after only about 150 operating hours, less than 6.5*10⁻¹² kg m² s⁻¹ chromium is vaporized, which corresponds to the aforesaid specification for stationary long-term operation of fuel cells. Later the vaporization rate drops much slower and in a nearly linear fashion with time.

As regards the temporal progression of the chromium vaporization rates of two alloys, NiCr (Ni28Cr24Fe) and FeNiCr (Fe19Cr11Ni), at 800° C. with no pre-oxidation in the production state and after gas aluminization, in the production state more chromium vaporizes from the alloys than 4.6*10⁻¹¹ kg m⁻² s⁻¹, which is the maximum allowable for mobile applications of fuel cells, and is thus completely unsuitable for use in fuel cells. After gas phase aluminization the inventively produced chromium retention layer immediately drops chromium vaporization to values that are less than 6.5*10⁻¹² kg m⁻² s⁻¹ so that the coated materials can also be used in long-term stationary fuel cells.

As regards microstructure images of an NiCr alloy and an FeNiCr alloy that were subjected to a temperature of 800° C. for 500 h, Cr₂O₃ and (Fe, Cr)₃O₄ layers formed on the NiCr alloy. Cr₂O₃ and (Mn, Cr)₃O₄ layers formed on the FeNi—Cr alloy. It is a disadvantage that these oxide layers contain chromium, which the high chromium vaporization explains.

As regards microstructure images of an NiCr layer and an FeNiCr layer that were first gas phase-aluminized and then subjected to a temperature of 800° C. for 100 h, a protective layer of Al₂O₃ is formed that does not contain any more chromium. The chromium vaporization previously described, which is lower by several orders of magnitude, explains this.

1. A method for producing a protective layer on a component that is for a fuel cell system and that is made of a chromium-containing alloy, the surface of the component containing aluminum, the method comprising:
forming a metastable Al₂O₃-containing, gas-tight chromium retention layer on the aluminum-containing surface at temperatures between 500 and 800° C.

2. A method according to claim 1, wherein the chromium-containing steel is a nickel-chromium alloy, an iron-nickel-chromium alloy, a cobalt-chromium alloy, an iron-chromium alloy, or an aluminum oxide former.

3. A method according to claim 1, further comprising:
enriching the surface of the component with aluminum prior to the forming of the chromium retention layer.

4. A method according to claim 3, wherein the thickness of the surface zone enriched with aluminum is selected to be clearly larger than is necessary for a first formation of the protective layer.

5. A method according to claim 3, wherein said enriching with aluminum includes conditioning the component in an inert or reducing atmosphere over a powder mixture comprising an aluminum alloy, an activator, and a sinter inhibitor.

6. A method according to claim 5, the conditioning of the component occurs at temperatures between 850 and 1080° C.

7. A method according to claim 5, wherein the conditioning lasts between 2 and 24 hours.

8. A method according to claim 5, wherein the inert atmosphere essentially comprises argon.

9. A method according to claim 5, wherein the reducing atmosphere essentially comprises hydrogen.

10. A method according to claim 5, wherein the activator is NH₄Cl or NH₄F.

11. A method according to claim 5, wherein the sinter inhibitor is Al₂O₃.

12. A method according to claim 5, wherein a build-up zone having a thickness of material between 20 and 100 m is deposited on the component surface.

13. A method according to claim 12, wherein the thickness of material is between 20 and 50 m.

14. A method according to claim 5, wherein a diffusion zone with a thickness of material between 20 and 100 m is enriched with aluminum.

15. A method according to claim 5, wherein a diffusion zone with a thickness of material between 20 and 50 m is enriched with aluminum.

16. A method according to claim 1, wherein a heat exchanger is selected as the component.

17. A method according to claim 1, wherein a conduit is selected as the component.

18. A method according to claim 1, wherein a housing is selected as the component.

19. A method according to claim 1, wherein a pump is selected as the component.

20. A component for a fuel cell system made of a chromium-containing alloy, comprising a chromium retention layer produced with the method in accordance with claim 1.

21. A component according to claim 20, wherein said component comprises a nickel-chromium alloy, an iron-nickel-chromium alloy, a cobalt-chromium alloy, an iron-chromium alloy, or an aluminum oxide former.

22. A heat exchanger for a fuel cell system comprising the component according to claim 20.

23. A conduit for a fuel cell system comprising the component according to claim 20.

24. A housing for a fuel cell system comprising the component according to claim 20.

25. A pump for a fuel cell system comprising the component according to claim 20.
